(19) United States
(12) Patent Application Publication
(10) Pub. No.: US 2025/0200123 A1
(43) Pub. Date: Jun. 19, 2025

(54) ENHANCED SEARCH REPORT BASED ON LEVERAGING SEARCH ENGINE APIs, LARGE LANGUAGE MODELS, AND WEB CRAWLERS

(71) Applicant: INTUIT INC., Mountain View, CA (US)

(72) Inventors: Vishal SONI, Sydney (AU); Yifan ZHAO, Sydney (AU); Kelsey Rae CONOPHY, Mountain View, CA (US); Jamie NICHOLSON, San Francisco, CA (US); Christian LAFRANCE, Sydney (AU)

(73) Assignee: INTUIT INC., Mountain View, CA (US)

(21) Appl. No.: 18/542,012

(22) Filed: Dec. 15, 2023

(51) Int. Cl. G06F 16/9538; G06F 9/54; G06F 16/951

(52) U.S. Cl. CPC G06F 16/9538; G06F 9/547; G06F 16/951

(57) ABSTRACT

Systems and methods that generate an enhanced search report, which provides a significant improvement over conventional searches are provided. The systems and methods leverage a combination of keyword-based searches using search engine APIs to return URLs that are hit by the searches, large language models to generate additional keywords based on contextual information, and web crawlers to search the returned URLs with the additional keywords. The enhanced search report is not confined to the conventional keyword-URL match, but instead provides a sophisticated capture and compilation of additional useful information.

### BACKGROUND

The Internet has been widely embraced by businesses of all sizes. Small businesses, for example, have leveraged the Internet for advertising and selling, information storage in the cloud, day-to-day management such as payrolls, data analytics, etc. Business applications such as QuickBooks® provided by Intuit® of Mountain View California have supported small businesses by providing computer applications that provide a seamless integration of many Internet centric functions.

Another advantage of the Internet is its widely accessible information highway. Search engines have been used for the past few decades to gather information from the Internet. Search engines are generally keyword based—returning webpages having the entered keywords. Several keyword based searches may be required to compile a threshold level of information for understanding and/or deciding an issue.

The Internet has also enabled training of large language models, which have been in vogue recently. Large language models provide an additional layer of complexity over the keyword based approach. For example, the large language models may use inferential learning—e.g., learning the meaning and contextual information of text—to understand and generate natural language text.

Although conventional business applications are integrated with the Internet, these applications only access and compile information that they are hard coded for. For instance, a conventional business application is hard coded to connect to a back-end server, download specific information, and upload updates to the information. As an example, a business application performing a payroll process connects to a back-end server of a payroll processing enterprise. As another example, an inventory management business application connects to a supplier's back-end server to receive shipping information of certain goods and update an inventory database accordingly.

Conventional business applications, however, do not have the flexibility to proactively search and compile useful information. This situation is undesirable and therefore a technical solution to this technical problem is needed.

### SUMMARY

Embodiments disclosed herein solve the aforementioned technical problems and may provide other solutions as well. One or more embodiments may provide an enhanced search functionality by leveraging search engine application program interfaces (APIs), large language models, and web crawlers. An input for a particular search area (e.g., license requirements) is received and a first set of search keywords are generated by using programming scripts. The first set of keywords may have different levels (e.g., based on different jurisdictions) and is provided to a search engine API. The search engine API returns a set of universal resource locators (URLs), which forms an initial search result. A large language model is applied on the input to generate a second set of search keywords, which generally have added complexity and nuance than the first set of search keywords. A web crawler is deployed using the second set of search keywords on the set of URLs. The results from the web crawler and the set of URLs is compiled to generate an enhanced search report.

### BRIEF DESCRIPTION OF THE DRAWINGS

The drawings are presented to illustrate various aspects of the principles disclosed herein. As the purpose is merely illustration, the drawings are not to be considered limiting.

FIG. 1 shows an example of a system configured for generating an enhanced search report, based on the principles disclosed herein.

FIG. 2 shows an example architecture configured for generating an enhanced search report, based on the principles disclosed herein.

FIG. 3 shows a flow diagram of an example method of generating an enhanced search report, based on the principles disclosed herein.

FIG. 4 shows a block diagram of an example computing device that implements various features and processes, based on the principles disclosed herein.

### DETAILED DESCRIPTION OF SEVERAL EMBODIMENTS

Embodiments disclosed herein generate an enhanced search report, which provides a significant improvement over conventional searches. The embodiments leverage a combination of keyword based searches using search engine APIs to return URLs that are hit by the searches, large language models to generate additional keywords based on contextual information, and web crawlers to search the returned URLs with the additional keywords. The enhanced search report is not confined to the conventional keyword-URL match, but instead provides a sophisticated capture and compilation of additional useful information.

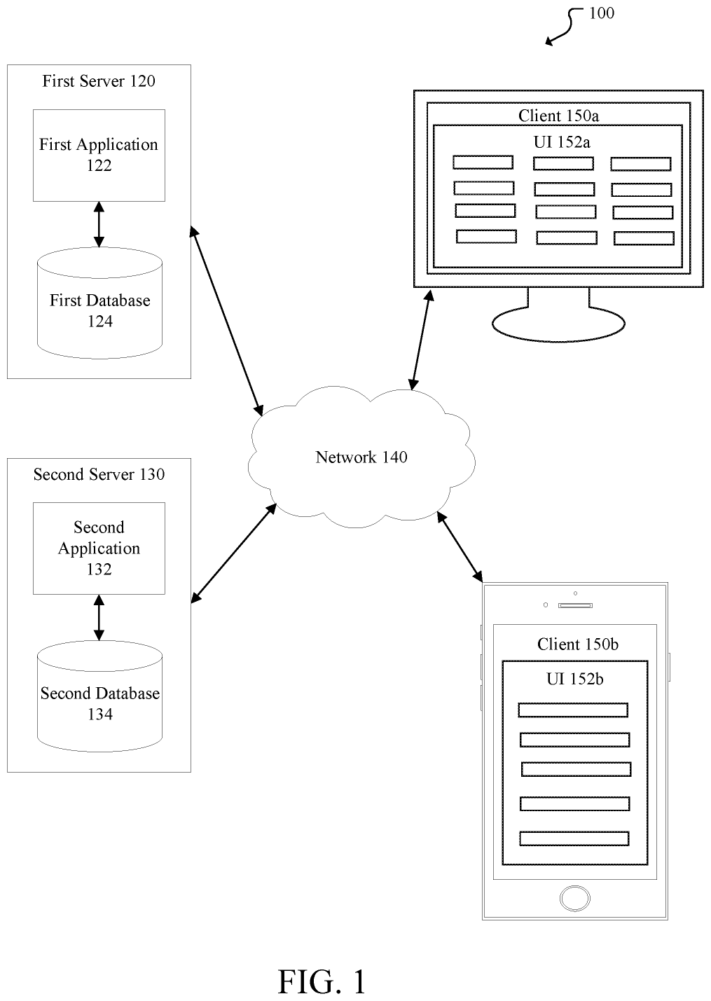

FIG. 1 shows an example of a system 100 configured for generating an enhanced search report, based on the principles disclosed herein. It should be understood that the components of the system 100 shown in FIG. 1 and described herein are merely examples and systems with additional, alternative, or fewer number of components should be considered within the scope of this disclosure.

As shown, the system 100 comprises client devices 150a, 150b (collectively referred to herein as “client devices 150”), and first and second servers 120, 130 interconnected by a network 140. The first server 120 hosts a first server application 122 and a first database 124 and the second server 130 hosts a second server application 132 and a second database 134. The client devices 150a, 150b have user interfaces 152a, 152b, respectively (collectively referred to herein as “user interfaces (UIs) 152”), which may be used to communicate with the server applications 122, 132 via the network 140.

The server applications 122, 132 implement the various operations disclosed throughout this disclosure. For example, the server applications 122, 132 receive inputs through the UIs 152 or through other systems/applications and generate a first set of search keywords and a second set of search keywords based on the inputs. In one or more embodiments, the server applications 122, 132 use programming scripts (e.g., Python scripts) to generate the first set of search keywords. In one or more embodiments, the server application 122, 132 use large language models to generate the second set of search keywords. The server applications 122, 132 store at least one of the user inputs and the search keywords in the corresponding databases 124, 134.

The server applications 122, 132 feed the first set of search keywords to search engine APIs to generate initial search results. The initial search results include URLs returned by the search engine APIs in response to the first set of search keywords. The server applications 122, 132 deploy a web crawler on the URLs using the second set of search keywords. The web crawler returns web crawler results. In one or more embodiments, the URLs and the web crawler results are combined and stored in the corresponding databases 124, 134. The server applications 122, 132 use the combination to generate the final, enhanced search report. The enhanced search report may be stored in the corresponding databases 124, 134 and/or used by downstream processes.

In addition to the inputs (received from users or other systems/applications) and search results, the databases 124, 134 may further store the programming scripts, large language models, and other data that may be required to implement the principles disclosed herein. For example, the databases 124, 134 can store instructions for executing the corresponding server applications 122, 132. It should be understood that the databases 124, 134 may be implemented in any form, including but not limited to, a relational database, an object-oriented database, a distributed database, and/or any other form of database.

Client devices 150 may include any device configured to present the user UIs 152 and receive user inputs through the UIs. The UIs 152 can be graphical user interfaces or command line interfaces. Regardless of the type of the UIs 152, they provide a window or any type of location for the users to provide their inputs. In one or more embodiments, the UIs 152 may invoke text-to-speech processing such that the users can provide voice answers to the questions.

Communication between the different components of the system 100 is facilitated by one or more APIs. APIs of system 100 may be proprietary and or may include such APIs as AWS APIs or the like. The network 140 may be the Internet and or other public or private networks or combinations thereof. The network 140 therefore should be understood to include any type of circuit switching network, packet switching network, or a combination thereof. Non-limiting examples of the network 140 may include a local area network (LAN), metropolitan area network (MAN), wide area network (WAN), and the like.

First server 120, second server 130, first database 124, second database 134, and client devices 150 are each depicted as single devices for ease of illustration, but those of ordinary skill in the art will appreciate that first server 120, second server 130, first database 124, second database 134, and/or client devices 150 may be embodied in different forms for different implementations. For example, any or each of first server 120 and second server 130 may include a plurality of servers or one or more of the first database 124 and second database 134. Alternatively, the operations performed by any or each of first server 120 and second server 130 may be performed on fewer (e.g., one) servers. In another example, a plurality of client devices 150 may communicate with first server 120 and/or second server 130. A single user may have multiple client devices 150, and/or there may be multiple users each having their own client devices 150.

Furthermore, it should be understood that the illustrated applications 122, 132 running on the servers 120, 130, and the databases 124, 134 being hosted by the servers 120, 130 are examples for carrying out the disclosed principles, and should not be considered limiting. Different portions of the server applications 122, 132 and, in one or more embodiments, the entirety of the server applications 122, 132 can be stored in the client devices 150. Similarly, different portions or even the entirety of the databases 124, 134 can be stored in the client devices 150. Therefore, the functionality described throughout this disclosure can be implemented at any portion of the system 100.

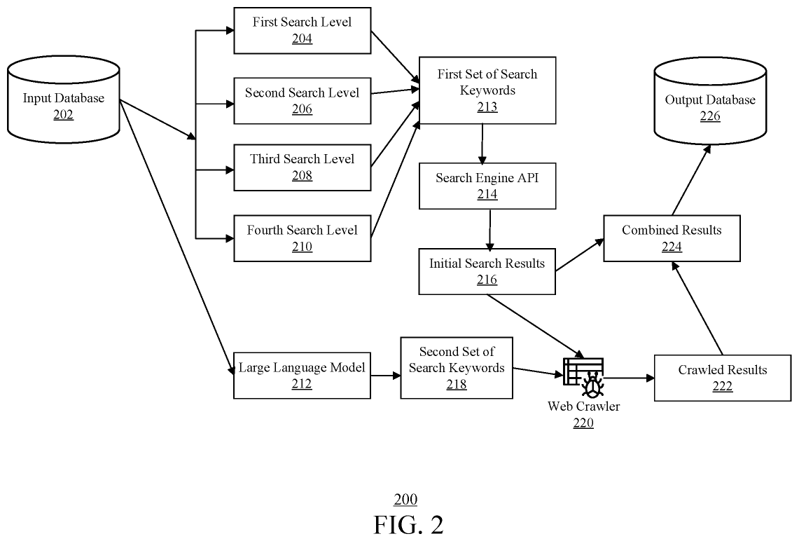

FIG. 2 shows an example architecture 200 configured for generating an enhanced search report, based on the principles disclosed herein. It should be understood that the components of the architecture 200 shown in FIG. 2 and described herein are examples and should not be considered limiting. Architectures with additional, alternative, or fewer number of components should be considered within the scope of this disclosure. The architecture 200 can be implemented by any portion of the system 100 shown in FIG. 1. The architecture 200 is generally used by end users or other systems/applications to generate an enhanced search report for different use cases, such as e.g., generating an enhanced search report for compliance with various business/license requirements of different jurisdictions. The compliance use case is described herein just for illustration, and any kind of information compilation should be considered within the scope of this disclosure.

An input database 202 stores inputs provided by the user associated with an entity (e.g., a business) or other systems/applications. The inputs may include, for example, keywords such as “county level compliance requirements,” “state level compliance requirements,” “federal level compliance requirements,” etc. In one or more embodiments, the keywords may be in the form of natural language questions, e.g., “I have a plumbing business in the city of Springfield, Sangamon county, Illinois. How do I comply with business license requirements for all these jurisdictions?” The stored inputs may include additional information such as the volume of the business, stock capital of the business, partnership status of the business, and/or any other type of relevant information that can be used for the search. The input database 202 may be any kind of database, including but not limited to, an object oriented database, a relational database, etc. For example, the input database 202 may include databases 124, 134 shown in FIG. 1.

From the inputs stored in the input database 202, different levels of searches may be generated, e.g., by using programming scripts. For example, a first search level 204 includes keywords for municipal level compliance requirements (e.g., city of Springfield), a second search level 206 includes keywords for county level compliance requirements (e.g., Sangamon county), a third search level 208 includes state level compliance requirements (e.g., state of Illinois), and a fourth search level 210 includes federal level compliance requirements (e.g., United States). The programming scripts can generally handle the different terms used by the respective jurisdiction-for instance, a county level requirement may use the term “compliance,” while the federal level requirement may use the term “licensure.” Using a pre-stored rules based approach, the programming scripts can generate appropriate keywords for the different levels of the search.

The keywords for the different search levels 204, 206, 208, 210 are compiled to generate a first set of search keywords 213 and fed to a search engine API 214. The search engine API 214 may be associated with any kind of search engine including, but not limited to, Google®, Bing®, Yahoo!®, and/or the like. Feeding the first set of search keywords 213 to the search engine API 214 generates initial search results 216. The initial search results 216 include URLs returned as hits by the search engine API 214. In one or more embodiments, the initial search results 216 may be stored as a text file. The initial search results 216, however, may not necessarily be well-organized to provide information with a desired level of usefulness and therefore may have to augmented by additional information as described below.

The inputs in the input database 202 may also be fed into a large language model 212. The large language model 212 can include any kind large language model, including but not limited to GPT-3.5 (OpenAI®), GPT-4 (OpenAI®), ChatGPT (OpenAI®), PaLM (Google®), LLaMa (Meta®), BLOOM, Ernie 3.0 Titan, and/or Claude, to name a few. The large language model 212 generates a second set of search keywords 218, which generally provide an additional layer of complexity compared to the first set of search keywords 213 generated by the programming scripts. The additional complexity may include, for example, generating synonyms as well as analogizing between the different contextual meanings. For example, a “license requirement” at the county level may be phrased as “necessary permits that have to be sought and granted” at the state level. As another example, because the laws have been written at different points in time, there may be a change in the shade of the meaning, and the second set of search keywords 218 generated by the large language model 212 takes this change into consideration. Therefore, any kind of additional language based nuance provided by the second set of search keywords 218 by leveraging the large language model 212 should be considered within the scope of this disclosure.

The initial search results 216 and the second set of search keywords 218 are provided to a web crawler 220. Web crawlers are well-known in the art and therefore are not described in detail herein. It should also be understood that the web crawler 220 may include any kind of web crawler known in the art. For example, the web crawler 220 may include any kind of open source web crawler such as Scrapy®, Pysider®, Webmagic®, Crawlee®, Node Crawler®, Beautiful Soup®, Nokogiri®, Crawler4j®, MechanicalSoup®, Apache Nutch®, Heritrix®, and/or the like. The web crawler 220 may include any kind of proprietary web crawler such as Amazonbot®, Bingbot®, DuckDuckBot®, Googlebot®, Yahoo Slurp®, Yandex Bot®, and/or the like.

In one or more embodiments, the web crawler 220 navigates to the URLs in the initial search results 216 using the second set of search keywords 218. Using the web crawler 220 for the navigation allows the accessing of embedded links, navigating across different webpages, and/or provides a generally more flexible approach than a simple keyword search. The web crawler 220 may further identify additional URLs compared to the initial search results 216 and navigate to these additional URLs as well. By crawling to the different URLs, the web crawler 220 generates crawled results 222.

The crawled results 222 and the initial search results 216 are combined to generate combined results 224. The combined results therefore include URLs in the initial search results 216, URLs detected by the web crawler 220, additional information (e.g., snippets) of the different URLs, and/or any other type of information. The combined results 224 are stored in an output database 226. The output database 226 may include any kind of database such as e.g., an object oriented database, relational database, etc. For example, the output database 226 may include databases 124, 134 shown in FIG. 1.

The combined results 224 can be used by any kind of process for information compilation. For example, a scraper may be used to scrape the relevant information from the URLs and the large language model 212 may be used to generate a report in a natural language format. The combined results 224 can also be used as a feedback to improve upon the first set of search keywords 213 generated by the different search levels 204, 206, 208, 210 and/or the second set of search keywords 218 generated by the large language model 212. Additionally, the combined results 224 may be presented to a user in a user interface. Therefore, any kind of downstream usage of the combined results 224 should be considered within the scope of this disclosure.

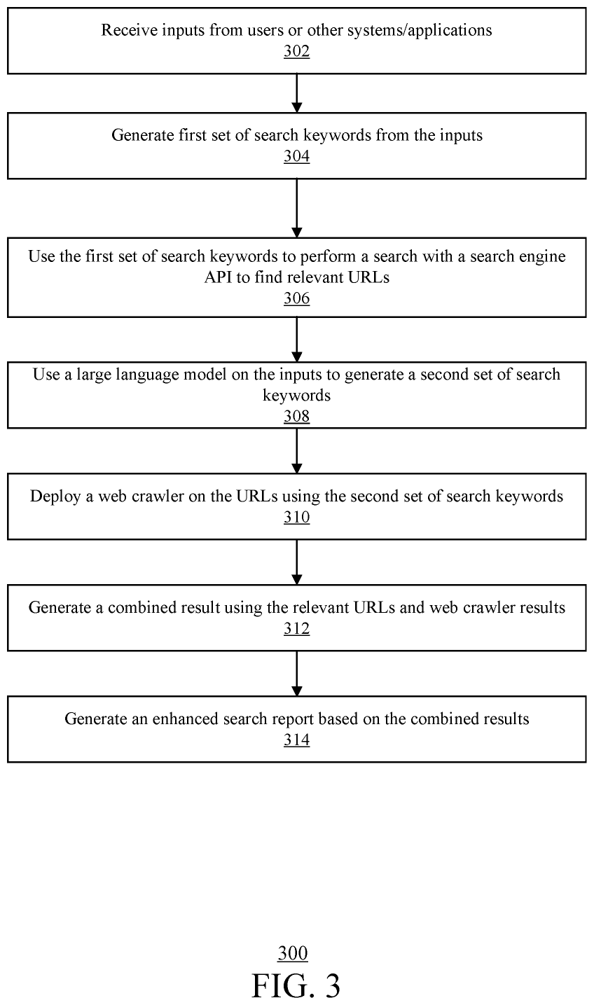

FIG. 3 shows a flow diagram of an example method 300 of generating an enhanced search report, based on the principles disclosed herein. It should, however, be understood that the steps of the method 300 are provided as examples and should not be considered limiting. Therefore, methods with alternative, additional, or fewer number of steps should be considered within the scope of this disclosure. The steps of the method 300 may be performed by any combination of components of the system 100 shown in FIG. 1 and/or components of the architecture 200 shown in FIG. 2.

The method begins at step 302, where inputs from users or other systems/applications are received. The inputs may be in any form including keywords, natural language, and/or the like. The inputs may be text inputs and/or audio-visual inputs. Therefore, any form and format of information provided by the user or other systems/applications should be consider within the scope of this disclosure. In one or more embodiments, the inputs may be associated with compiling permit and/or license information for small businesses. In these embodiments, the inputs may include the name of the local jurisdiction, state jurisdiction, regional jurisdiction, and/or national jurisdiction.

At step 304, a first set of search keywords is generated from the inputs. For example, a programming script (e.g., a Python script) implementing different rules and categories may be run on the inputs. Continuing with the above example of compiling permit and/or license information, the rules and categories may generate a first subset of keywords for a local jurisdiction, a second subset of keywords for state jurisdiction, a third subset of keywords for regional jurisdiction, and a fourth subset of keywords for national jurisdiction. Generally, for the present example, these different subset of keywords may progressively expand the geographical scope of the permit and/or license information.

In one or more embodiments, the first set of search keywords may include a default collection of keywords augmented by an input. The default collection of keywords may be based on previous searches for similar information, e.g., the search keywords that generated relevant hits in the past. The augmentation to the default collection may include the addition of new search keywords, deletion of existing search keywords, use of synonyms with more likelihood of generating relevant hits, and/or the like.

At step 306, the first set of search keywords is used to perform a search with a search engine API to find relevant URLs. Non-limiting examples of search engines include Google®, Bing®, Yahoo!®, and/or the like. Regardless of which search engine is used, the search engine API returns the relevant URL sources. In one or more embodiments, multiple search engine APIs may be used. For example, the first set of keywords are provided to the multiple search engine APIs, which may return overlapping but not the exact set of URLs, which may then be combined into a final source of the URLs. Generally, multiple search APIs may be used as complements to each other. In one or more embodiments, the search engine APIs may be organized according to a priority list: a first search engine API may be used first, and should a response be not received timely, a second search engine API may be used next.

At step 308, a large language model is used on the inputs to generate a second set of search keywords. Some non-limiting example large language models include GPT-3.5 (OpenAI®), GPT-4 (OpenAI®), ChatGPT (OpenAI®), PaLM (Google®), LLaMa (Meta®), BLOOM, Ernie 3.0 Titan, and/or Claude, to name a few. In one or more embodiments, prompt engineering techniques may be used. When the inputs are received from a user, the prompt engineering techniques may include instructing the large language model as to the user's preferences, the user's geographical location, the user's profile, and/or the like to generate outputs based on the instructions.

At step 310, a web crawler is deployed on the URLs returned by the search engine APIs using the second set of search keywords. The web crawler accesses the URLs, performs keyword searches on the URLs, navigates to embedded links within the URLS, and/or navigates across different URLs. The web crawler may return additional URLs, additional information, scraped information, and/or the like.

At step 312, a combined result is generated using the relevant URLs and web crawler results. For example, URLs from the search engine APIs are combined with additional information gathered by the web crawler and are appended to the same file/database. The combination therefore provides a more comprehensive source of information compared to conventional systems.

At step 314, an enhanced search report is generated based on the combined results. For example, information from URLs in the combined result can be scraped to generate the enhanced search report. Alternatively or additionally, a large language model is used to generate the enhanced search report in natural language. The generated enhanced search report can be provided to a user and/or used by different downstream processes.

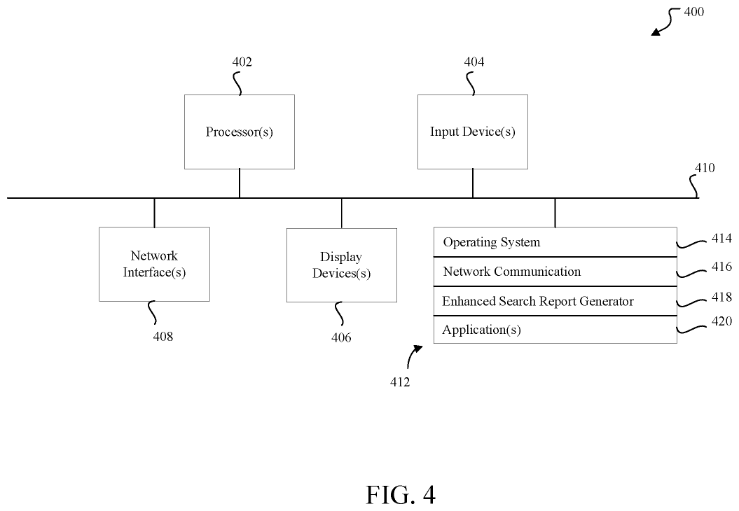

FIG. 4 shows a block diagram of an example computing device 400 that implements various features and processes, based on the principles disclosed herein. For example, computing device 400 may function as first server 120, second server 130, client 150a, client 150b, or a portion or combination thereof in some embodiments. The computing device 400 may function as one or more portions of the architecture 200 and may perform one or more steps of the method 300. The computing device 400 is implemented on any electronic device that runs software applications derived from compiled instructions, including without limitation personal computers, servers, smart phones, media players, electronic tablets, game consoles, email devices, etc. In one or more embodiments, the computing device 400 includes one or more processors 402, one or more input devices 404, one or more display devices 406, one or more network interfaces 408, and one or more computer-readable media 412. Each of these components is be coupled by a bus 410.

Display device 406 includes any display technology, including but not limited to display devices using Liquid Crystal Display (LCD) or Light Emitting Diode (LED) technology. Processor(s) 402 uses any processor technology, including but not limited to graphics processors and multi-core processors. Input device 404 includes any known input device technology, including but not limited to a keyboard (including a virtual keyboard), mouse, track ball, and touch-sensitive pad or display. Bus 410 includes any internal or external bus technology, including but not limited to ISA, EISA, PCI, PCI Express, USB, Serial ATA or FireWire. Computer-readable medium 412 includes any non-transitory computer readable medium that provides instructions to processor(s) 402 for execution, including without limitation, non-volatile storage media (e.g., optical disks, magnetic disks, flash drives, etc.), or volatile media (e.g., SDRAM, ROM, etc.).

Computer-readable medium 412 includes various instructions 414 for implementing an operating system (e.g., Mac OS®, Windows®, Linux). The operating system may be multi-user, multiprocessing, multitasking, multithreading, real-time, and the like. The operating system performs basic tasks, including but not limited to: recognizing input from input device 404; sending output to display device 406; keeping track of files and directories on computer-readable medium 412; controlling peripheral devices (e.g., disk drives, printers, etc.) which can be controlled directly or through an I/O controller; and managing traffic on bus 410. Network communications instructions 416 establish and maintain network connections (e.g., software for implementing communication protocols, such as TCP/IP, HTTP, Ethernet, telephony, etc.).

Enhanced search report generate module 418 includes instructions that implement the disclosed embodiments for generating the enhanced search report.

Application(s) 420 may comprise an application that uses or implements the processes described herein and/or other processes. The processes may also be implemented in the operating system.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random-access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer-implemented method, comprising:
receiving an input corresponding to a search area;
generating, by using a programming script, a first set of search keywords based on the input, the first set of search keywords being separated into different search levels associated with the search area;
transmitting, the first set of search keywords to a search engine application programming interface (API);
receiving a set of universal resource locators (URLs) from the search engine API;
generating, using a large language model, a second set of search keywords from the input;
deploying a web crawler on the set of URLs using the second set of search keywords;
receiving crawled results from the web crawler; and
generating a search report on the search area and the search levels based on the set of URLs and the crawled results.

2. The computer-implemented method of claim 1, the receiving of the crawled results from the web crawler further comprising:
receiving URLs in addition to the set of URLs received from the search engine API.

3. The computer-implemented method of claim 1, the receiving of the crawled results from the web crawler further comprising:
receiving scraped information from at least one URL of the set of URLs received from the search engine API.

4. The computer-implemented method of claim 1, the generating of the search report further comprising:
generating the search report by using the large language model on the set of URLs and the crawled results.

5. The computer-implemented method of claim 1, the generating of the search report further comprising:
scraping information from the first set of URLs and the crawled results; and
generating the search report based on the scraped information.

6. The computer-implemented method of claim 1, the search area being compliance for an entity, the generating of the first set of search keywords separated into the different search levels further comprising:
generating a first subset of search keywords of municipal level compliance, a second subset of search keywords for county level compliance, a third subset of search keywords for state level compliance, and a fourth subset of search keywords for federal level compliance; and
compiling the first, the second, the third, and the fourth subset of search keywords to generate the first set of search keywords.

7. The computer-implemented method of claim 1, further comprising:
generating a feedback for the programming script based on at least one of the set of the URLs or the crawled results.

8. The computer-implemented method of claim 1, further comprising:
generating a feedback for the large language model based on at least one of the set of the URLs or the crawled results.

9. A system comprising:
a non-transitory storage medium storing computer program instructions; and
at least one processor configured to execute the computer program instructions to cause the system to perform operations comprising:
receiving an input corresponding to a search area;
generating, by using a programming script, a first set of search keywords based on the input, the first set of search keywords being separated into different search levels associated with the search area;
transmitting, the first set of search keywords to a search engine application programming interface (API);
receiving a set of universal resource locators (URLs) from the search engine API;
generating, by using a large language model, a second set of search keywords from the input;
deploying a web crawler on the set of URLs using the second set of search keywords;
receiving crawled results from the web crawler; and
generating a search report on the search area and the search levels based on the set of URLs and the crawled results.

10. The system of claim 9, the receiving of the crawled results from the web crawler further comprising:
receiving URLs in addition to the set of URLs received from the search engine API.

11. The system of claim 9, the receiving of the crawled results from the web crawler further comprising:
receiving scraped information from at least one URL of the set of URLs received from the search engine API.

12. The system of claim 9, the generating of the search report further comprising:
generating the search report by using the large language model on the set of URLs and the crawled results.

13. The system of claim 9, the generating of the search report further comprising:
scraping information from the first set of URLs and the crawled results; and
generating the search report based on the scraped information.

14. The system of claim 9, the search area being compliance for an entity, the generating of the first set of search keywords separated into the different search levels further comprising:
generating a first subset of search keywords of municipal level compliance, a second subset of search keywords for county level compliance, a third subset of search keywords for state level compliance, and a fourth subset of search keywords for federal level compliance; and
compiling the first, the second, the third, and the fourth subset of search keywords to generate the first set of search keywords.

15. The system of claim 9, the operations further comprising:
generating a feedback for the programming script based on at least one of the set of the URLs or the crawled results.

16. The system of claim 9, the operations further comprising:
generating a feedback for the large language model based on at least one of the set of the URLs or the crawled results.

17. A non-transitory storage medium storing computer program instructions, which when executed by at least one processor causes operations comprising:
receiving an input corresponding to a search area;
generating, using a programming script, a first set of search keywords based on the input, the first set of search keywords being separated into different search levels associated with the search area;
transmitting, the first set of search keywords to a search engine application programming interface (API);
receiving a set of universal resource locators (URLs) from the search engine API;
generating, by using a large language model, a second set of search keywords from the input;
deploying a web crawler on the set of URLs using the second set of search keywords;
receiving crawled results from the web crawler; and
generating a search report on the search area and the search levels based on the set of URLs and the crawled results.

18. The non-transitory storage medium of claim 17, the receiving of the crawled results from the web crawler further comprising:
receiving URLs in addition to the set of URLs received from the search engine API.

19. The non-transitory storage medium of claim 17, the receiving of the crawled results from the web crawler further comprising:
receiving scraped information from at least one URL of the set of URLs received from the search engine API.

20. The non-transitory storage medium of claim 17, the generating of the search report further comprising:
generating the search report by using the large language model on the set of URLs and the crawled results.
